(19) United States
(12) Patent Application Publication
(10) Pub. No.: US 2026/0215627 A1
(43) Pub. Date: Jul. 30, 2026

(54) REMOVABLE HANDLE, REMOVABLE COOKWARE HANDLE AND COOKWARE HAVING SAME

(71) Applicant: BRADSHAW HOME, Rancho Cucamonga, CA (US)

(72) Inventors: Flavio De Roma Leao, Upland, CA (US); Chad DeLisle, Brighton, MA (US); Robert Cavalcanti, Marlborough, MA (US)

(73) Assignee: BRADSHAW HOME, Rancho Cucamonga, CA (US)

(21) Appl. No.: 19/459,852

(22) Filed: Jan. 26, 2026

Related U.S. Application Data
(60) Provisional application No. 63/749,949, filed on Jan. 27, 2025.

(51) Int. Cl. A47J 45/07

(52) U.S. Cl. CPC A47J 45/071

(57) ABSTRACT

A removable handle including a body, a button located in the body, the button being configured to be pressed by a user. a lever assembly mounted in the body, the lever assembly being configured to move when the button is pressed, and a clamp, the clamp being configured move between an engagement position and a disengagement position in response to movement of the lever assembly. A cookware including the removable handle is also provided.

### CROSS-REFERENCE TO RELATED APPLICATION(S)

This application claims the benefit of U.S. Provisional Application No. 63/749,949, filed on Jan. 27, 2025, the entire contents of which are hereby expressly incorporated by reference into the present application.

### BACKGROUND OF THE DISCLOSURE

### Field of the Disclosure

The present disclosure is directed to a handle, a cookware handle and cookware for use with the handle. More particularly, the disclosure is directed to a removable handle that can be attached and detached to an object such as cookware and cookware having same.

### Description of the Related Art

Conventional cookware, such as pots and pans, has fixed handles which are integrally cast with the cookware or are attached or mounted using rivets or other hardware. The fixed handles are not intended to be removed by the user and can only be removed with great difficulty and even resulting in damage to the handle or cookware. Once removed, it may be difficult or impossible to re-attach the handle to the cookware.

Conventional cookware including fixed handles require extra storage space and take up additional room on a cooktop. The handles of cookware adjacent to each other on a cooktop may interfere with each other. In addition, there are extra material costs and manufacturing steps when producing the cookware and the fixed handles. Damage to a handle can result in the total loss of the cookware. Handles that are attached to cookware when in use absorb heat from the cookware while the cookware is being heated.

### SUMMARY OF THE DISCLOSURE

The removable handle of the disclosure is configured to allow a user to attach and detach the handle from an object such as cookware, for example, a pot or a pan. This arrangement provides many advantages including diminishing heat transfer from the cookware to the handle to allow the user to manipulate the cookware using the handle without getting burned or requiring the use of a protective cover such as oven mitts. By using cookware with a removable handle, the stove top becomes less crowded and the handles of multiple pieces of cookware on the stovetop do not interfere with each other.

The cookware has one or more designated locations designed to interface with the handle, as opposed to anywhere on the cookware. The handle connects on the exterior of the pan. In other handle designs, the connection with the handle goes over the rim of the cookware, which could interact with food being cooked and/or damage/scratch the interior cookware coating. Storage of cookware with removeable handles is also made easier. Cookware can be easily stacked inside each other. In addition, costs of the cookware may be lower by the provision of fewer handles per number of pieces of cookware. One handle can be used for a variety of sizes of cookware or multiple handles of varying appropriate sizes can be provided.

The removable handle is not limited to use with cookware and those having ordinary skill in the art will understand the handle can be used with any object, whether or not the object is intended to be subject to differing temperatures such as heating or cooling temperatures uncomfortable or even dangerous to a user.

An exemplary aspect of the disclosure includes a removable handle including a body, a button located in the body, the button being configured to be pressed by a user, a lever assembly mounted in the body, the lever assembly being configured to move when the button is pressed and a clamp, the clamp being configured move between an engagement position and a disengagement position in response to movement of the lever assembly.

The lever assembly may include a lever configured to be rotated by the button. The clamp has a first end attached to a first end of the lever, and a hook located at a second end opposite the first end of the clamp, the hook being configured to engage an object.

The hook may include a first portion extending in a first direction and a second portion extending in a second direction different than the first direction, the first portion including an inclined surface, the inclined surface facing the lever.

The removable handle may further include a first resilient member, the first resilient member being configured to impart a first biasing force to rotate the clamp to cause the hook move to the engagement position, and a second resilient member, the second resilient member configured to impart a second biasing force to rotate the clamp to cause the hook move to the engagement position. The lever assembly may further include a link attached to the lever, the second biasing force acting on the hook through the link to the lever to the clamp. The button is configured to overcome the first and second biasing forces when pushed by the user to rotate the lever and the clamp to cause the hook move to the disengagement position.

The body may include a grooved portion, a hollow portion having openings at opposite end, and a through-hole arranged at a top of the body. The button is located in the through-hole, and the lever is located in the grooved portion and the second resilient member is located in the hollow portion.

The removable handle may further include a housing, the housing being configured to attach to the object. The housing includes a top side wall, and a bottom side wall opposite the top side wall. The bottom side wall includes a through-hole configured to receive the hook.

The housing has a third side configured to face the object, the third side being perpendicular to the top side wall, and the bottom side wall, the third side being open.

An exemplary aspect of the disclosure includes a handle for cookware. The handle includes a body, the body includes a grooved portion, a hollow portion having openings at opposite ends, and a through-hole located at a top of the body, a button located in the through-hole, the button being configured to be pressed by a user, a lever located in the grooved portion, the lever being configured to rotate when the button is pressed, a clamp having a first end attached to a first end of the lever, the clamp being configured to rotate with rotation of the lever, the clamp having a hook arranged at a second end opposite the first end of the clamp, the hook being configured to move between an engagement position and a disengagement position, a first resilient member configured to impart a first biasing force to rotate the clamp to move the hook to the engagement position, a link attached to the lever, a second resilient member arranged in the hollow portion, the second resilient member configured to impart a second biasing force to rotate the clamp to move the hook to the engagement position, the second biasing force acting on the hook through the link to the lever to the clamp. The button is configured to overcome the first and second biasing forces when pushed by the user to rotate the lever and the clamp to move the hook to the disengagement position.

The handle for cookware may further include a housing, the housing being configured to attach to the cookware, the housing including a top side wall, and a bottom side wall opposite the top side wall. The bottom side wall includes a through-hole configured to receive the hook.

The housing may include a third side configured to face the cookware, the third side being perpendicular to the top side wall and the bottom side wall, the third side being open.

A cookware for cooking food may include the above aspects of the handle for cookware and further include a cookware body and a first bracket located on an exterior of the cookware body and configured to receive the hook of the handle when the hook is in the engagement position.

The cookware may further include a second bracket located opposite the first bracket.

The hook may include an inclined surface, and the first bracket may include an inclined surface configured to engage with the inclined surface of the hook when the hook is in the engagement position.

The housing may include a third side configured to face the cookware, the third side being perpendicular to the top side wall, and the bottom side wall, the third side being open and configured to receive the first bracket, and interior surfaces of the top side wall, and the bottom side wall, bear on corresponding surfaces of the first bracket.

An exemplary aspect of the disclosure includes a cookware, the cookware including a cookware body, a first bracket located on an exterior of the cookware body, and a handle removably attachable to the first bracket, the handle including a body, a button located in the body, the button being configured to be pressed by a user, a lever assembly mounted in the body, the lever assembly being configured to move when the button is pressed, and a clamp, the clamp being configured move between an engagement position and a disengagement position in response to movement of the lever assembly. The first bracket is configured to engage the clamp when the clamp is in the engagement position

The first bracket may include an inclined surface configured to engage with the inclined surface of the hook when the hook is in the engagement position.

### BRIEF DESCRIPTION OF THE DRAWINGS

The present disclosure will become more fully understood from the detailed description given hereinbelow and the accompanying drawings which are given by way of illustration only, and thus are not limited to the present disclosure.

FIG. 1 is a perspective view of a cookware in combination with a removable handle according to an exemplary aspect of the disclosure;

FIG. 2 is a perspective view of the cookware without the removable handle of FIG. 1 according to an exemplary aspect of the disclosure;

FIG. 3 is an exploded perspective view of the removable handle according to an exemplary aspect of the disclosure;

FIG. 4 is a cross-sectional view of the removable handle in combination with the cookware according to an exemplary aspect of the disclosure;

FIG. 5 is an is a cross-sectional view of the removable handle in combination with a cookware during a removal operation according to an exemplary aspect of the disclosure;

FIGS. 6A and 6B are lower perspective views of a pot while the removable handle is attached and during a removal operation of the removable handle according to another exemplary aspect of the disclosure;

FIG. 7 is a perspective view of a pot configured to be usable with the removable handle according to the exemplary aspect of the disclosure of FIG. 6; and

FIGS. 8A and 8B are cross-sectional views of the removable handle while attached to cookware and during a removal operation according to the exemplary aspect of the disclosure of FIG. 6.

### DETAILED DESCRIPTION OF THE DISCLOSURE

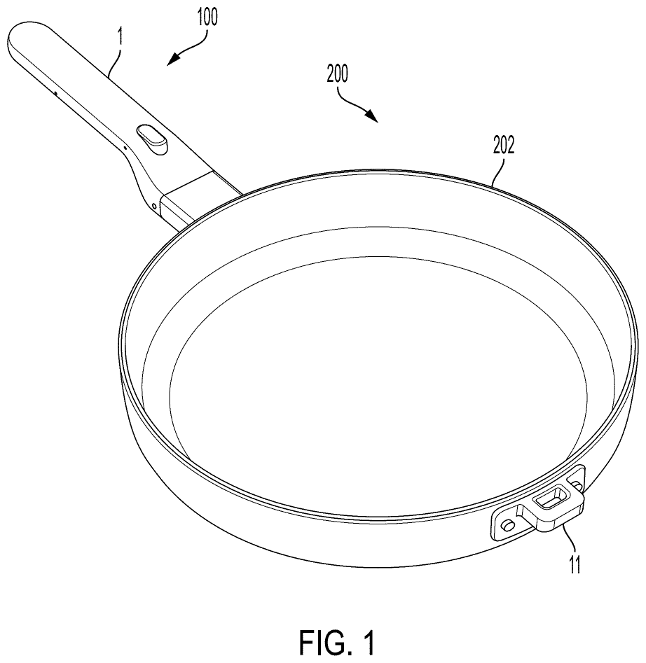

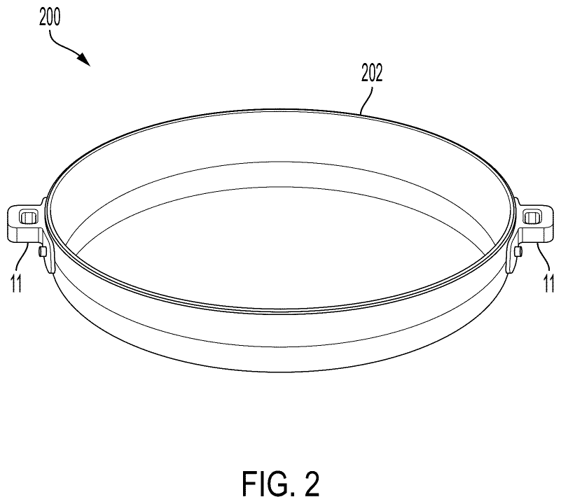

FIG. 1 shows an exemplary aspect of a removable handle 100 attached to an example of a cookware 200. The cookware 200 includes one or more brackets 11 that can be used in combination with the handle 100. FIG. 2 shows an exemplary aspect of the cookware 200 shown in FIG. 1 with an exemplary aspect of the bracket 11 to be used with the handle 100. The bracket 11 may be provided on one side or on opposite sides of the cookware 200.

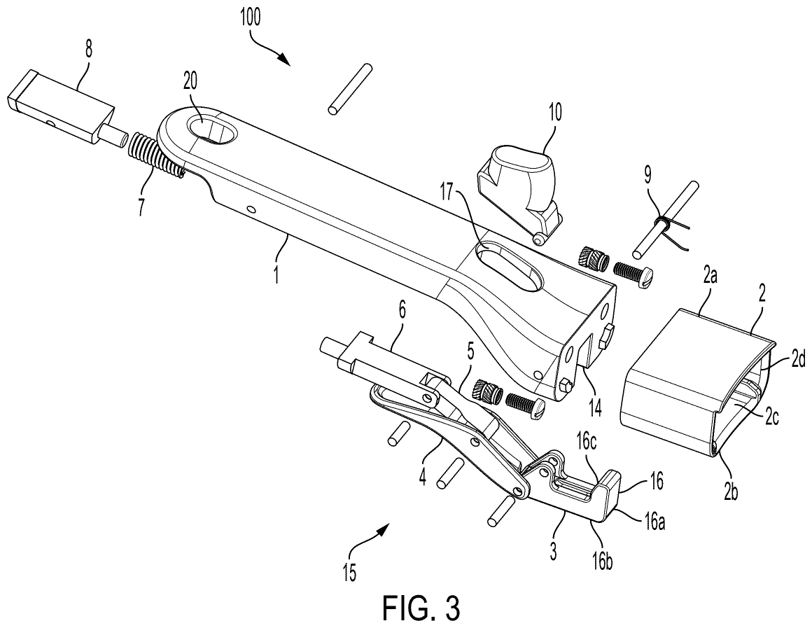

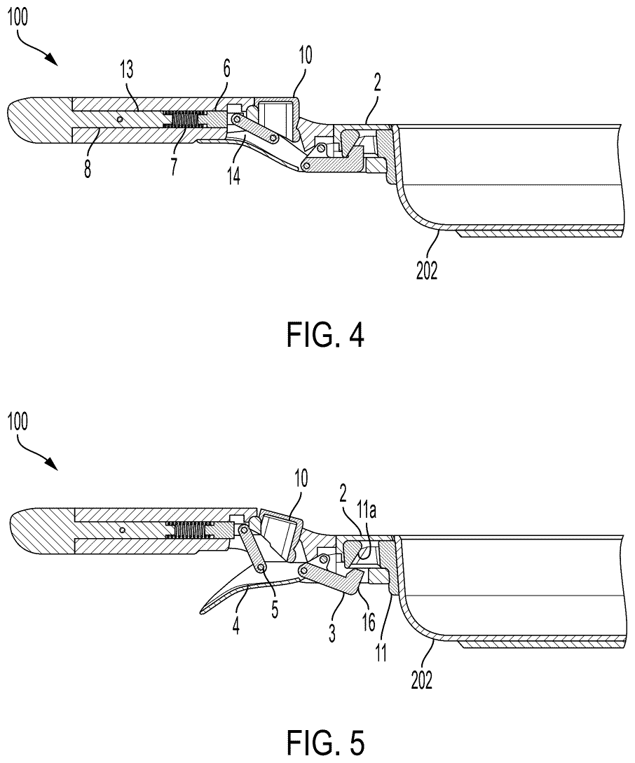

FIG. 3 is an exploded perspective view of the handle 100 according to an exemplary aspect of the disclosure and FIGS. 4 and 5 are cross-sectional views of the handle 100 while attached and during detachment, respectively, according to an exemplary aspect of the disclosure. The shape and size of the handle 100 is not particularly limited, but it is advantageous to provide an ergonomic arrangement.

As shown in FIGS. 3-5, the handle 100 includes a body 1 configured to be gripped by a user and sized to be appropriate for the object to which the handle is attached, for example, cookware 200. A button 10 is located in the body 1. A top of the body 1 may include a hole 17 to receive the button. The button 10 is configured to be operated by a user, for example by pressing the button 10. A lever assembly 15 is mounted in the body 1. The lever assembly 15 is moved when the button 10 is pressed. A clamp 3 is provided to move between an engagement position and a disengagement position in response to movement of the lever assembly 15.

The lever assembly 15 includes a lever 4. The button 10 is configured to rotate the lever 4, for example, by being pressed by the user, thereby coming into contact with the lever 4. The clamp 3 has a first end attached to a first end of the lever 4 and a hook 16 arranged at a second opposite end of the clamp 3. The hook 16 may have a first portion 16a extending in a first direction and a second portion 16b extending in a second direction different than the first direction. The first portion 16a of the hook 16 may include an inclined surface 16c. The inclined surface 16c may face the lever 4.

The handle 100 may include a first resilient member 7 to impart a first biasing force to rotate the clamp 3 to have the hook 16 move to an engagement position. The first resilient member 7 may be, for example, a spring. The handle body 1 has a hollow portion 13. The hollow portion 13 has an opening at each of two opposite ends. The opening at the first end may include a back plug 8 to seal the opening at the first end of the hollow portion 13. The resilient member 7 may be inserted into the hollow portion 13 at the first end to provide the biasing force to the lever 4. The back plug 8 is inserted into the hollow portion 13 behind the resilient member 7 and fixes an end of the resilient member 7. The other opposite end of the resilient member 7 is in contact with a spring slider 6 inserted into the opposite second end of the hollow portion 13. The lever assembly 15 may further include a link 5 attached to the lever 4. The spring slider 6 is attached to the lever 4 through the link 5 that is articulated to both the lever 4 and the spring slider 6. The biasing force of the spring 7 is transmitted through the spring slider 6 to the lever 4 through link 5 to bias the button 10 to an upward position and to bias the hook 16 of the clamp 3 to rotate upwardly to an engagement position.

A second resilient member 9, such as a torsion spring, is configured to impart a second biasing force to rotate the clamp 3 to have the hook 16 move to the engagement position. The second biasing force acts on the hook 16 through the link 5 to the lever 4 to the clamp 3. The button 10 is configured to overcome the first and second biasing forces when pushed by the user to rotate the lever 4 and the clamp 3 to have the hook 16 move to a disengagement position. Operation of the lever 4 and clamp 3 will be described in greater detail below.

A grooved portion 14 is formed on the bottom of the body 1 to receive at least a portion of the lever assembly 15. One end of the handle 100 can include a through-hole 20 for hanging the handle on a hook, for example. An opposite end of the handle 100 can include the hole 17 formed on a top portion such that hole 17 extends through to the grooved portion 14. The button 10 is arranged in the hole 17 to allow a user to manipulate the button 10 to operate the lever assembly 15.

The handle 100 may include a housing 2. The housing 2 may be configured to be attached to an object to which the handle 100 is to be attached. The housing 2 includes a top side wall 2a, and a bottom side wall 2b opposite the top side wall 2a. The bottom side wall 2b includes a through-hole 2c configured to receive the clamp 3. The housing 2 has a third side 2d configured to face the object. The third side 2d is perpendicular to the top side wall 2a, and the bottom side wall 2b. The third side 2d is open to receive a portion of the object that the handle is to be attached.

In an exemplary aspect of the disclosure, the handle 100 may be used as a handle for cookware 200 for cooking food, for example on a stove top or in an oven. The cookware 200 may include a body 202 and the bracket 11 attached to an outer facing surface of the cookware body 202. A second bracket 11 may be attached to an opposites outer facing side of the cookware body 202 and may have a similar shape to the first bracket 11. The brackets 11 may be attached to the cookware body 202 for example, by rivets or any other suitable method. The bracket 11 is attached to an outer surface of the cookware body 202, for example an upper portion of an outer lip.

The bracket 11 may include an inclined surface 11a that is configured to engage with the inclined surface 16c of the hook 16 when the handle is mounted to the bracket 11 and the hook 16 is in the engagement position. As shown in FIG. 3, the end of the handle 1 proximate the cookware includes the housing 2 attached to the handle body 1. The housing 2 is hollow and the side 2c having the opening can slip over the exterior of the bracket 11 of the cookware 200. The housing 2 acts as a sleeve to surround the bracket 11. The handle 100 is attached to the bracket 11 by the combination of the housing 2 providing a surface that bears on an exterior surface of the bracket 11 and the inclined surface 16c of the hook 16 engaging the inclined surface 11a of the bracket 11 that locks the handle 1 to the bracket 11 while in the engagement position. The housing 2 opening is sized to fit sufficiently tight over the bracket 11 to provide the user with confidence in control of the cookware 200.

As described above, the lever assembly 15 includes the lever 4 and the clamp 3. The button 10 is configured to press down on the lever 4. One end of the lever 4 is pivotally attached to a clamp 3. When the button 10 is pushed down by the user, the lever 4 is pushed down and the clamp 3 rotates so that an end of the clamp 3, which is meant to be proximate the cookware, is lowered to a disengagement position. The end of the clamp 3 proximate the cookware can include a hook 16 configured to engage with the bracket 11 formed on the cookware. For example, the bracket 11 can include an insertion hole on a bottom portion to receive the hook 16. The hook 16 can be moved on to the bracket 11. When the user releases the button 10, the lever 4 may be biased to push the button 10 upwards. At that time, the clamp 3 rotates so that the hook 16 engages with the bracket 11, thereby attaching the handle 1 to the cookware.

As shown in FIG. 3, the end of the handle 1 proximate the cookware includes a housing 2 attached to the handle body. The housing 2 is hollow and includes an opening that slips over the exterior of the bracket 11 of the cookware. The housing 2 acts as a sleeve to surround the bracket 11. The handle 1 is attached to the bracket 11 by the combination of the housing 2 providing a surface that bears on the bracket 11 and the hook that locks the handle 1 to the bracket 11. The housing 2 opening is sized to fit sufficiently tight over the bracket 11 to provide the user with confidence in control of the cookware. The housing 2 may be integrally formed with the handle 1 or formed as a separate piece that is attached at one end of the handle 1. The housing has a hole located in the bottom to allow the hook to penetrate through to engage with the bracket 11.

In an exemplary aspect of the disclosure according to FIG. 4, the handle 100 is shown attached to the bracket 11 of a piece of cookware 200. The button 10 is not pressed down and the hook 16 is engaged with the bracket 11 of the cookware. The spring slider 6 is pulled by the resilient force of the handle spring 7. The spring slider 6, in turn, pulls one end of the link 5, pivotally connected to the spring slider 6, upward. Another end of the link 5, pivotally connected to the lever 4, pulls the lever 4 upward. An end of the lever 4 pivotally connected to the clamp 3 provides a first rotational force to the clamp 3 to allow the hook to move to the engagement position. The second pivot point of the clamp 3 is biased using the resilient member 9. The resilient member 9 acts to bias the clamp 3 so the hook 16 engages with the bracket 11 of the cookware 200.

FIG. 5 shows the operation to disengage the handle 100 from the cookware 200. A user presses the button 10, which rotates the lever downward, overcoming the biasing force of the first resilient member 7 and the second resilient member 9. The end of the lever 4 pivotally connected to the clamp 3 provides a second rotational force, opposite to the first rotational force, to the clamp 3 to allow the hook 16 to move to the disengagement position. Releasing the button 10 allows the biasing force of the handle spring 7 and the torsion spring acting thereon to provide the first rotational force to the clamp 3 to allow the hook to move back to the engagement position.

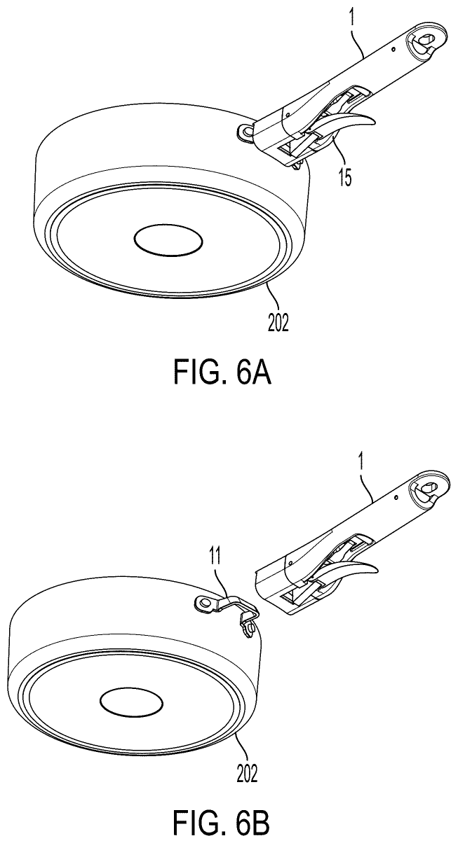

In an exemplary aspect of the disclosure according to FIGS. 6A and 6B, the handle 100 is respectively shown detached and attached to bracket 11 of a piece of different cookware 200. The operation is substantially the same as that shown in FIGS. 4 and 5, but the bracket 11 and the hook 16 are shaped differently to provide an alternative arrangement when a less robust connection may be used.

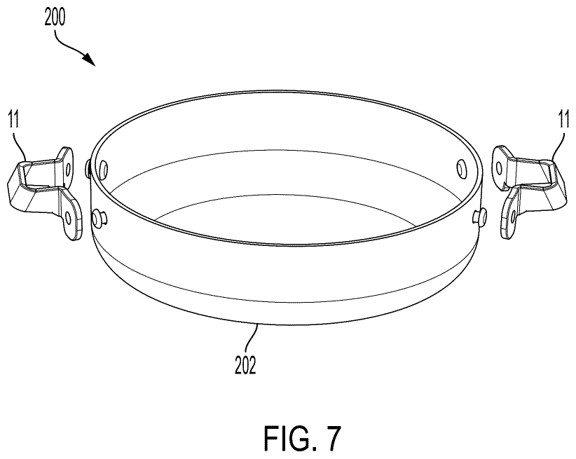

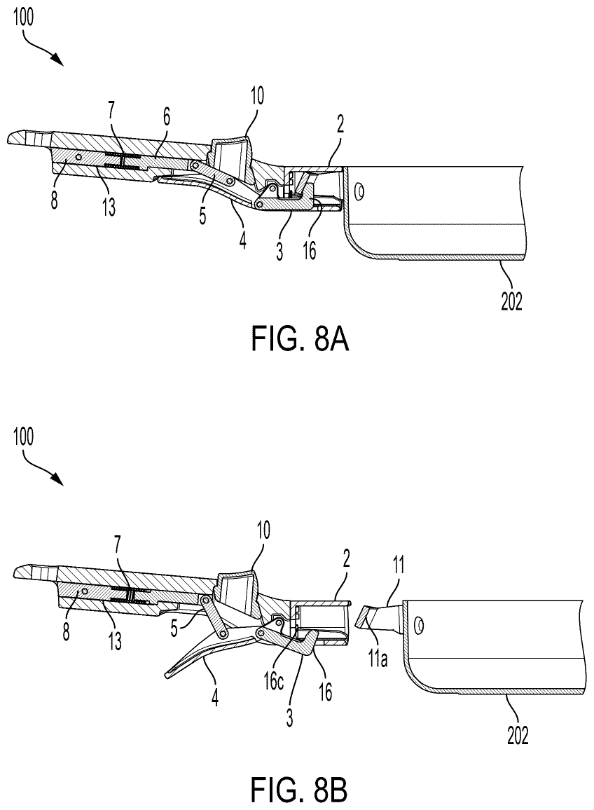

FIG. 7 shows an exemplary aspect of the cookware 200 shown in FIG. 6. FIGS. 8A and 8B are cross-sectional views of the handle 100 while attached and during detachment, respectively, according to the exemplary aspect of the disclosure of FIG. 6. FIG. 8A shows the handle 100 is attached to the bracket 11 of a piece of cookware 200. FIG. 8B shows the operation to disengage the handle 100 from the cookware 200.

The housing 2 according to an exemplary aspect of the disclosure 2 should be sized to match the bracket 11 arranged on a cookware for use with the handle.

The shape and size of the hook 16 is not particularly limited but should be configured to engage the bracket 11 of the cookware.

The shape and size of the lever 4 is not particularly limited but should be configured to provide sufficient force to have the hook engage the bracket 11 of the cookware.

The shape and size of the link 5 is not particularly limited but should be configured to transmit the force of the handle spring 7 through the spring slider 6 to the lever 4.

The spring slider 6 (block-spring) is shown in FIG. 3 according to an exemplary aspect of the disclosure. The shape and size of the spring slider 6 is not particularly limited but should be configured to transmit the force of the handle spring 7 to the link 5.

The back plug 8 also can act as a cap-handle according to an exemplary aspect of the disclosure. The shape and size of the back plug 8 is not particularly limited but should be configured to close the opening at the back end of the handle 1 and provide a fixed seating for the handle spring 7.

The shape and size of the button 10 is not particularly limited but it is advantageous to provide an ergonomic arrangement. The button 10 should be configured to fit into the through-hole 17 arranged at the top of the handle 1.

Pins may be arranged at the pivot points according to an exemplary aspect of the disclosure. The pins are an example of a way to provide pivoting links but the disclosure is not limited thereto as any suitable arrangement for providing pivoting links may be employed.

The first resilient member 7 and the first resilient member 9 according to an exemplary aspect of the disclosure may be springs to provide a biasing force but the disclosure is not limited thereto as any suitable arrangement for providing a biasing force may be employed.

The FIGS. show various cookware 200 for use with the handle. Types of cookware can include, but are not limited to, frying pans, Dutch ovens, saucepans, sauté pans, and the like. Each of the pieces of cookware can come in various sizes. Each piece of cookware can have the bracket 11 affixed to an outer circumference by any suitable method such as riveting. More than one bracket 11 can be fixed to the outer circumference of the cookware. Some of the pieces of cookware can be provided with removable lids.

Although the example aspects of the present disclosure have been described in detail with reference to the accompanying drawings, the present disclosure is not limited thereto and can be embodied in many different forms without departing from the technical concept of the present disclosure. Therefore, the example aspects of the present disclosure are provided for illustrative purposes only but not intended to limit the technical concept of the present disclosure. The scope of the technical concept of the present disclosure is not limited thereto. Therefore, it should be understood that the above-described example aspects are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A removable handle comprising:
a body,
a button located in the body, the button being configured to be pressed by a user;
a lever assembly mounted in the body, the lever assembly being configured to move when the button is pressed; and
a clamp, the clamp being configured move between an engagement position and a disengagement position in response to movement of the lever assembly.

2. The removable handle according to claim 1, wherein the lever assembly includes a lever configured to be rotated by the button, and
wherein the clamp has a first end attached to a first end of the lever, and a hook located at a second end of the clamp opposite the first end of the clamp, the hook being configured to engage an object.

3. The removable handle according to claim 2, wherein the hook includes a first portion extending in a first direction and a second portion extending in a second direction different than the first direction, the first portion including an inclined surface, the inclined surface facing the lever.

4. The removable handle according to claim 2, further comprising:
a first resilient member, the first resilient member being configured to impart a first biasing force to rotate the clamp to cause the hook to move to the engagement position; and
a second resilient member, the second resilient member configured to impart a second biasing force to rotate the clamp to cause the hook to move to the engagement position,
wherein the lever assembly further comprises a link attached to the lever, the second biasing force acting on the hook through the link to the lever to the clamp, and
wherein the button is configured to overcome the first and second biasing forces when pushed by the user to rotate the lever and the clamp to cause the hook to move to the disengagement position.

5. The removable handle according to claim 4, wherein the body includes;
a grooved portion;
a hollow portion having openings at opposite ends; and
a through-hole located at a top of the body,
wherein the button is located in the through-hole,
wherein the lever is located in the grooved portion, and
wherein the second resilient member is located in the hollow portion.

6. The removable handle according to claim 2, further comprising a housing, the housing being configured to attach to the object, the housing including:
a top side wall; and
a bottom side wall opposite the top side wall, the bottom side wall including a through-hole configured to receive the hook.

7. The removable handle according to claim 6, wherein the housing has a third side configured to face the object, the third side being perpendicular to the top side wall and the bottom side wall, the third side being open.

8. A handle for cookware, the handle comprising:
a body, the body including;
a grooved portion;
a hollow portion having openings at opposite ends; and
a through-hole located at a top of the body;
a button located in the through-hole, the button being configured to be pressed by a user;
a lever located in the grooved portion, the lever being configured to rotate when the button is pressed;
a clamp having a first end attached to a first end of the lever, the clamp being configured to rotate with rotation of the lever, the clamp having a hook located at a second end of the clamp opposite the first end of the clamp, the hook being configured to move between an engagement position and a disengagement position;
a first resilient member configured to impart a first biasing force to rotate the clamp to move the hook to the engagement position;
a link attached to the lever; and
a second resilient member located in the hollow portion, the second resilient member configured to impart a second biasing force to rotate the clamp to move the hook to the engagement position, the second biasing force acting on the hook through the link to the lever to the clamp,
wherein the button is configured to overcome the first and second biasing forces when pushed by the user to rotate the lever and the clamp to move the hook to the disengagement position.

9. The handle for cookware according to claim 8, further comprising a housing, the housing being configured to attach to the cookware, the housing including:
a top side wall; and
a bottom side wall opposite the top side wall, the bottom side wall including a through-hole configured to receive the hook.

10. The handle for cookware according to claim 9, wherein the housing has a third side configured to face the cookware, the third side being perpendicular to the top side wall and the bottom side wall, the third side being open.

11. A cookware for cooking food, the cookware comprising:
the handle according to claim 8;
a cookware body; and
a first bracket located on an exterior of the cookware body, the first bracket being configured to receive the hook of the handle when the hook is in the engagement position.

12. The cookware according to claim 11, further comprising a second bracket located opposite the first bracket.

13. The cookware according to claim 11, wherein the hook has an inclined surface, and
wherein the first bracket includes an inclined surface configured to engage with the inclined surface of the hook when the hook is in the engagement position.

14. The cookware according to claim 11, wherein the handle further comprises a housing, the housing being configured to attach to the cookware, the housing including:
a top side wall; and
a bottom side wall opposite the top side wall, the bottom side wall including a through-hole configured to receive the hook,
wherein the housing is configured to receive the first bracket.

15. The cookware according to claim 14, wherein the housing has a third side configured to face the cookware, the third side being perpendicular to the top side wall and the bottom side wall, the third side being open and configured to receive the first bracket, and
wherein interior surfaces of the top side wall and the bottom side wall bear on corresponding surfaces of the first bracket.

16. A cookware comprising:
a cookware body;
a first bracket located on an exterior of the cookware body; and
a handle removably attachable to the first bracket, the handle including:
a body,
a button located in the body, the button being configured to be pressed by a user;
a lever assembly mounted in the body, the lever assembly being configured to move when the button is pressed; and
a clamp, the clamp being configured move between an engagement position and a disengagement position in response to movement of the lever assembly,
wherein the first bracket is configured to engage the clamp when the clamp is in the engagement position.

17. The cookware according to claim 16, wherein the lever assembly includes a lever, configured to be rotated the button, and
wherein the clamp has a first end attached to a first end of the lever, and a hook located at a second end of the clamp opposite the first end of the clamp, the hook being configured to engage the first bracket.

18. The cookware according to claim 17, wherein the hook includes a first portion extending in a first direction and a second portion extending in a second direction different than the first direction, the first portion including an inclined surface, the inclined surface facing the lever, and
wherein the first bracket includes an inclined surface configured to engage with the inclined surface of the hook when the hook is in the engagement position.

19. The cookware according to claim 17, further comprising:
a first resilient member, the first resilient member being configured to impart a first biasing force to rotate the clamp to cause the hook move to the engagement position; and
a second resilient member, the second resilient member configured to impart a second biasing force to rotate the clamp to cause the hook to move to the engagement position,
wherein the lever assembly further comprises a link attached to the lever, the second biasing force acting on the hook through the link to the lever to the clamp, and
wherein the button is configured to overcome the first and second biasing forces when pushed by the user to rotate the lever and the clamp to cause the hook to move to the disengagement position.

20. The cookware according to claim 19, wherein the body includes;
a grooved portion;
a hollow portion having openings at opposite ends; and
a through-hole located at a top of the body,
wherein the button is located in the through-hole, and
wherein the lever assembly is located in the grooved portion, and
wherein the second resilient member is located in the hollow portion.
